(19) United States
(12) Patent Application Publication
(10) Pub. No.: US 2010/0057675 A1
(43) Pub. Date: Mar. 4, 2010

(54) Search Provider Recommendation

(75) Inventors: Ryen W. White, Kirkland, WA (US); Mikhail Bilenko, Bellevue, WA (US); Eric D. Brill, Bellevue, WA (US); Raman Chandrasekar, Seattle, WA (US); Scott K. Imig, Redmond, WA (US); Matthew Richardson, Seattle, WA (US); Robert L. Rounthwaite, Fall City, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/199,568

(22) Filed: Aug. 27, 2008

(51) Int. Cl. G06F 17/30

(52) U.S. Cl. 707/3; 707/E17.108; 707/E17.109

(57) ABSTRACT

A component presents access to a recommended search provider via a user interface element. In an example embodiment, a device-implemented method for recommending a search provider includes acts of receiving, ascertaining, and modifying. A search query input is received. A recommended search provider is ascertained at least partially responsive to the search query input. A user interface is modified to indicate the recommended search provider.

### BACKGROUND

An enormous amount of information is accessible via the internet. Businesses, governments, educational institutions, societal organizations, and individuals have placed billions of web pages on the World Wide Web. Although a significant portion of the information in the world is now available over the internet, locating particular information that is desired can be problematic because of the sheer quantity and overall diversity of the information. Internet search engines are designed to help with the task of locating and retrieving desired information.

Search engines crawl the internet and index the accessible information. When a user issues a search query to a search engine, the search engine attempts to produce a ranked list of information sources (e.g., web sites) that are available over the internet and that pertain to the search query. Unfortunately, a given search engine may not include in the ranked list a reference to an information source that the user would consider relevant, even if the relevant information source is actually available over the internet.

### SUMMARY

A component presents access to a recommended search provider via a user interface element. In an example embodiment, a device-implemented method for recommending a search provider includes acts of receiving, ascertaining, and modifying. A search query input is received. A recommended search provider is ascertained at least partially responsive to the search query input. A user interface is modified to indicate the recommended search provider.

In another example embodiment, a device is capable of recommending a search provider. The device includes a search provider recommendation component to present a recommended search provider to a user. The search provider recommendation component includes a search input interface component, a recommended search provider ascertainment component, and a user interface modification component. The search input interface component is to receive a search query input. The recommended search provider ascertainment component is to ascertain the recommended search provider at least partially responsive to the search query input. The user interface modification component is to modify a user interface to indicate the recommended search provider.

In an example implementation, when a user selects the recommended search provider, a set of search results from the recommended search provider may be presented. In another example implementation, a representation of a confidence level that is associated with the recommended search provider may be presented. In yet another example implementation, a special-purpose search provider (e.g., a vertical search provider corresponding to a particular category) may be recommended. In still yet another example implementation, a search provider may be recommended based on a financial benefit that is available through the recommended search provider.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other systems, methods, devices, media, apparatuses, arrangements, and other example embodiments are described herein.

### BRIEF DESCRIPTION OF THE DRAWINGS

The same numbers are used throughout the drawings to reference like and/or corresponding aspects, features, and components.

FIG. 1 illustrates an example scenario in which a recommended search provider is indicated in conjunction with a search recommendation user interface (UI) element.

FIG. 2 illustrates an example search recommendation UI element as part of a browser window.

FIG. 3 is a flow diagram that illustrates an example of a method for recommending a search provider.

FIG. 4 is a block diagram that illustrates an example search provider recommendation component.

FIG. 5 depicts a browser window that illustrates example origination sources for a search query input.

FIG. 6 is a flow diagram that illustrates an example of a method for predicting a recommended search provider.

FIG. 7 depicts a browser window that illustrates an example indication of a recommended search provider.

FIG. 8 depicts a browser window that illustrates example implementations of indicators for revealing a confidence level supporting a search provider recommendation.

FIG. 9 depicts a browser window that illustrates an example mode for a search recommendation UI element when the browser is pointed to a homepage of a search provider.

FIG. 10 depicts a browser window that illustrates an example mode for recommending a special purpose search provider.

FIG. 11 depicts a browser window that illustrates an example mode for recommending a search provider when a financial benefit is available to the user.

FIG. 12 is a block diagram illustrating example devices that may be used to implement embodiments for recommending search providers.

### DETAILED DESCRIPTION

Web search engines provide users with keyword access to the Web's content. Although users occasionally use other engines, they are typically loyal to a single search engine, even when it may not satisfy their needs. This is true even though the cost of switching engines is relatively low. It is likely that some users are satisfied with the experience on their engine of choice. However, it is nevertheless conceivable that many users would be happier using a different search engine, at least from time to time.

Some users may not want the inconvenience or the burden of adapting to a new engine. Others may be unaware of how to change the default settings in their Web browser to point to a (different) particular engine, or they may be unaware of other Web search engines that exist and may provide more satisfactory service. Because different search engines perform well compared to competing search engines for some queries but poorly for other queries, excessive search engine loyalty may actually hinder users' ability to search effectively. These users may benefit from being able to leverage the strengths of different search engines for the different queries on which they perform better as compared to other search engines given one or more criteria. Such leveraging can increase the likelihood of a successful and/or enjoyable search experience.

Meta-search engines attempt to leverage different strengths of different search engines by combining their results in some manner. In other words, meta-search engines try to help people utilize the collective power of multiple search engines. After requesting search result listings for a given query from multiple different search engines, a meta-search engine attempts to combine these lists in a way that “optimizes” the relevance of the combination. The information retrieval research community has studied meta-search in great detail; however, the focus has been on how to merge results from multiple engines.

Meta-search suffers from the following shortcomings. First, strong brand loyalty may discourage users from migrating to a meta-search engine. Second, meta-search engines merge search results from different search engines and therefore eliminate the benefits of the interface features and global-page optimizations (e.g., search result diversity within a given result set) provided by the individual engines. Third, meta-search providers may be blocked by search engines as their use can negatively impact brand awareness and advertising revenue.

In contrast, certain example embodiments that are described herein enable users to frequent their favorite search provider, but an alternative search provider may be recommended to them during their browsing and/or searching activities. A search provider may be recommended for one or more of the following example reasons: First, another search provider may be predicted to provide more desired results (e.g., more relevant results, results offering a financial or other benefit, etc.) for the current search query. Second, the user may seem dissatisfied with the current set of search results. Third, it can be inferred (or users may explicitly indicate) that they desire topic coverage, result set recency, or another similar distinguishing feature in the result set. These and other criteria may form at least part of the basis for a search provider recommendation.

In example embodiments, a UI component facilitates access (e.g., easy, immediate, one-click, etc. access) to multiple search providers and makes recommendations about which provider is expected to be most effective for the current search query. This component promotes search provider switching by encouraging users to switch, at least temporarily if not permanently, to a different search provider for queries on which the recommended search provider is likely to provide more appropriate performance than the users' default search provider.

Spontaneous switching, when users navigate to other search providers on their own accord, may occur for a number of reasons. Users may be dissatisfied with the search results or the interface of a current search provider, they may be lured to the other providers by advertising campaigns or word of mouth, or they may switch by accident. However, results of a log-based study show that merely about 10% of search sessions currently involve more than one search provider. By proactively encouraging users to try alternative search providers for appropriate queries, and hence increasing the percentage of search sessions that contain switching, more effective user searching may be promoted for a significant fraction of search queries.

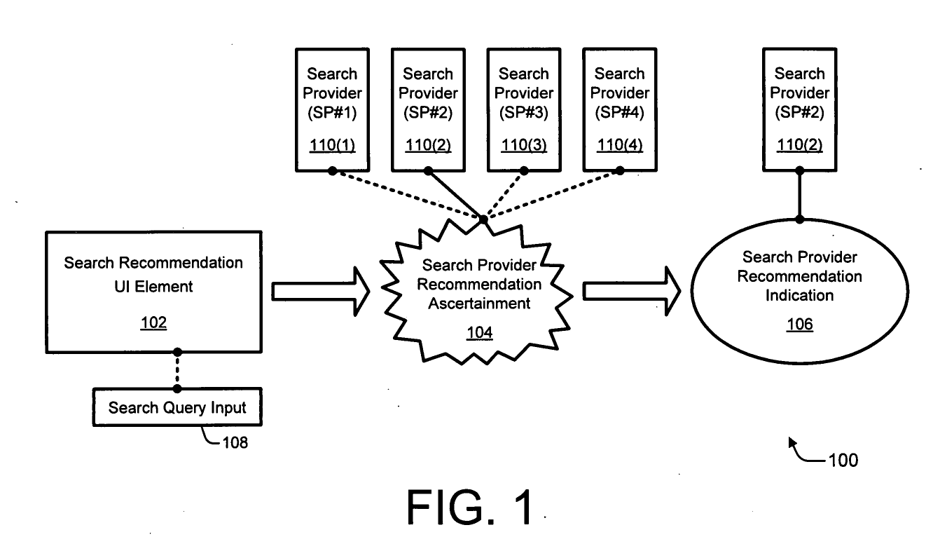

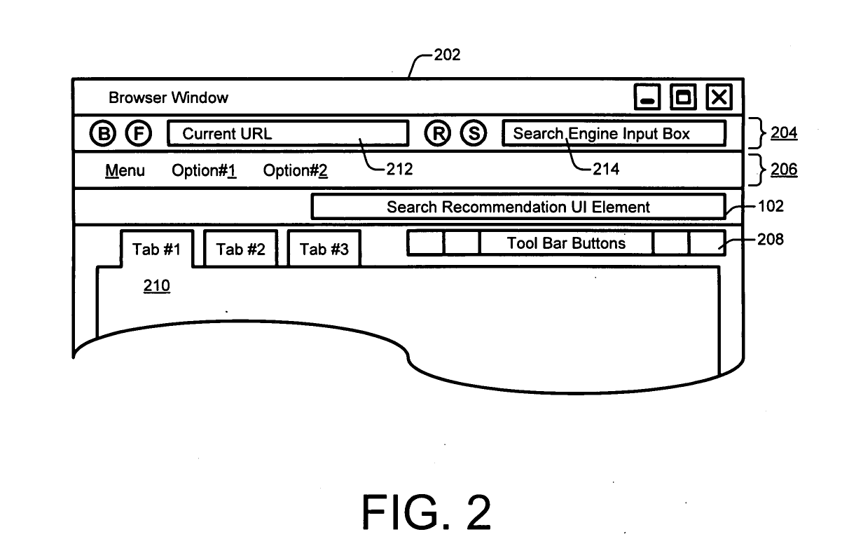

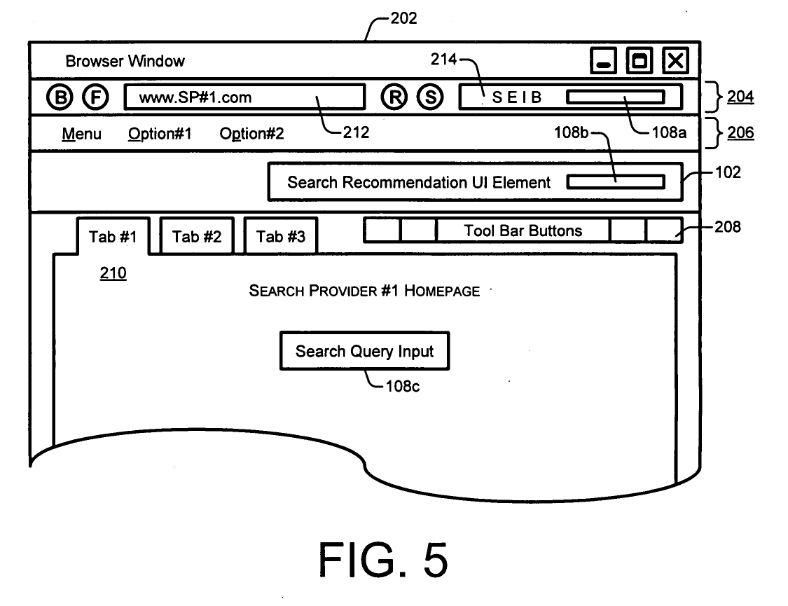

FIG. 1 illustrates an example scenario 100 in which a recommended search provider is indicated in conjunction with a search recommendation UI element 102. As illustrated, in addition to search recommendation UI element 102, scenario 100 includes search provider recommendation ascertainment 104, search provider recommendation indication 106, a search query input 108, and multiple search providers 110. Example embodiments for search recommendation UI element 102 are shown in FIGS. 2, 5, and 7-11 and are described herein below. Examples for search query input 108 are described herein below with particular reference to FIG. 5.

For example embodiments of scenario 100, a user provides a search query input 108 in a system having a search recommendation UI element 102. In response, a search provider recommendation ascertainment 104 occurs responsive at least partially to search query input 108. In other words, the ascertainment is performed when a search query is received, and it may be based on the contents of the search query as well as one or more other criteria. Multiple search providers 110(1), 110(2), 110(3), and 110(4) are considered for the potential recommendation. Although four search providers 110 are shown, more or fewer than four may be considered in the analysis. Each search provider 110 may comprise a search engine and/or a search interface, plus any accompanying interface functionality.

The recommended search provider may be ascertained by prediction at a local system (e.g., a user-operated device) or by receiving the recommended search provider from a remote system (e.g., a web server or other cloud-based service). In the illustrated example, search provider 110(2) is ascertained to be the recommended search provider. After ascertaining the recommending search provider 110(2), a search provider recommendation indication 106 is presented to a user in conjunction with search recommendation UI element 102. For example, a representation of search provider 110(2) may be presented to the user. The presentation of search provider recommendation indication 106 can promote search provider switching. The recommended search provider 110(2) may be indicated to the user when it is predicted to provide a desirable search experience, such as by providing a more appropriate search results listing.

FIG. 2 illustrates an example search recommendation UI element 102 as part of a browser window 202. As illustrated, browser window 202 includes a navigation zone 204, a menu zone 206, search recommendation UI element 102, tool bar buttons 208, and multiple tabs 210.

For certain example embodiments, navigation zone 204 includes a backward (B”) button, a forward (“F”) button, a refresh (“R”) button, and a stop (“S”) button. Navigation zone 204 also includes a current uniform resource locator (URL) block 212 and a search engine input box 214. Menu zone 206 offers access to drop-down, menu-based controls for the browser program of browser window 202.

Toolbar buttons 208 have one or more buttons offering relatively easy access to a number of tools. Example tools include, but are not limited to, printing tools, page manipulation tools, general internet tools, browser configuration tools, home page commands, and so forth. Although not explicitly shown, browser window 202 may also include button and/or menu access to favorite URLs. A given browser window 202 may include different (e.g., more, fewer, etc.) elements, features, and capabilities than those that are shown in the accompanying FIGS. Moreover, such elements, features, and capabilities may be rearranged or otherwise modified.

Browser window 202 also includes search recommendation UI element 102. In an example embodiment, search recommendation UI element 102 is presented to the user as a button panel for the toolbar of browser window 202. The button(s) on the panel may update, blink, gleam, etc. with recommendations if a search provider with likely more appropriate search results for the current search query is ascertained. In one implementation, when the user visits a non-search-related page, the button panel is visible and has the same background color as the browser. Alternatively, it can completely disappear, be minimized to a small button (e.g., equal to the size of and/or as one of the tool bar buttons 208), and so forth.

It should be noted that search recommendation UI element 102 need not be presented as part of a browser window 202 or a browser program. It may instead be presented as a part of another program or be presented as a stand-alone program. For example, search recommendation UI element 102 may be presented within its own program window, as an operating system tool, as a “gadget”, and so forth.

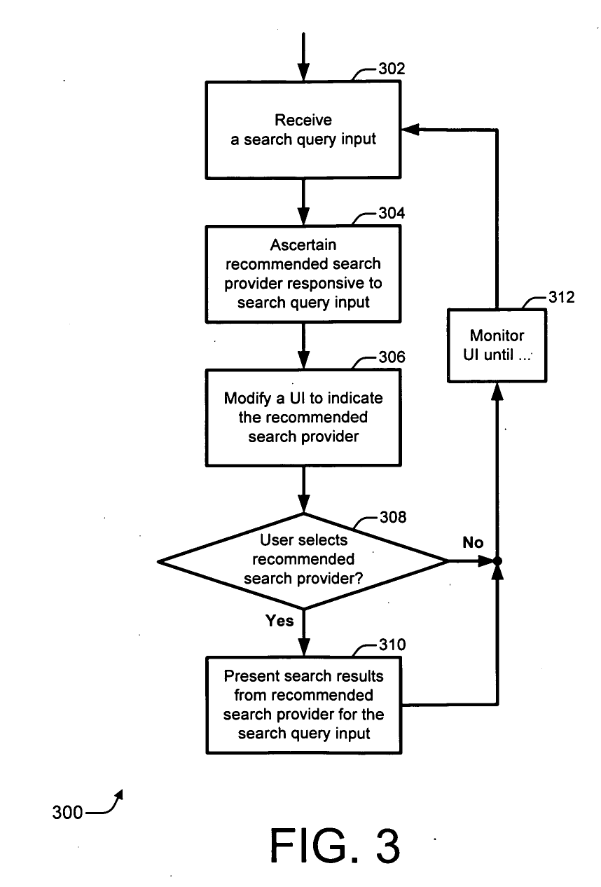

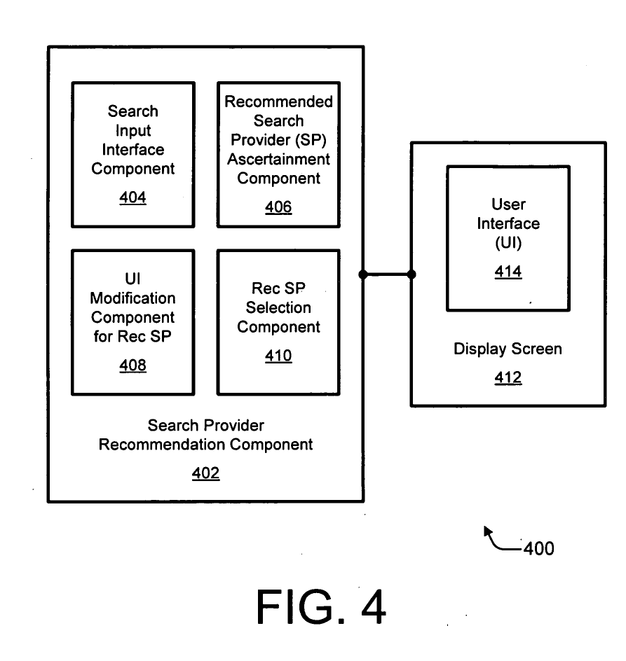

FIG. 3 is a flow diagram 300 that illustrates an example of a method for recommending a search provider. Flow diagram 300 includes six blocks 302-312. Implementations of flow diagram 300 may be realized, for example, as processor-executable instructions and/or as part of a search provider recommendation component 402 (which is introduced below with reference to FIG. 4).

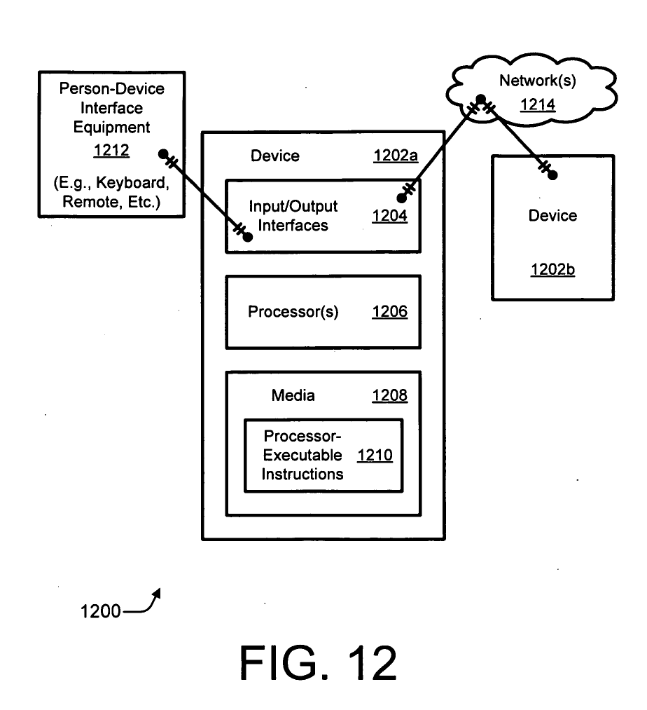

The acts of the different flow diagrams that are described herein may be performed in many different environments and with a variety of different devices, such as by one or more processing devices (e.g., of FIG. 12). The order in which the methods are described is not intended to be construed as a limitation, and any number of the described blocks can be combined, augmented, rearranged, and/or omitted to implement a respective method, or an alternative method that is equivalent thereto. Although specific elements of certain other FIGS. are referenced in the description of these flow diagrams, the methods may be performed with alternative elements.

For example embodiments, at block 302, a search query input is received. At block 304, a recommended search provider is ascertained responsive to the search query input. For example, the recommended search provider may be predicted locally or may be received from a remote location that performed the search provider recommendation prediction (e.g., after receiving the search query input from the local device). The prediction mechanism may be based on one or more criteria that are analyzed to estimate a confidence level (e.g., a probabilistic, discriminative, etc. confidence level) associated with a search provider that reflects a likelihood that it can provide a relatively high or higher quality search experience. The prediction mechanism may be, for example, implemented using a machine learning algorithm.

At block 306, a UI is modified to indicate the recommended search provider. For example, a representation of the recommended search provider may be emphasized. More generally, the UI may be modified by changing a user interface element to indicate the recommended search provider or by adding a user interface element to indicate the recommended search provider. At block 308, it is detected if the user selects the recommended search provider. For example, the user may select the representation of the recommended search provider via mouse, keyboard, touch, microphone, or other person-device interface equipment.

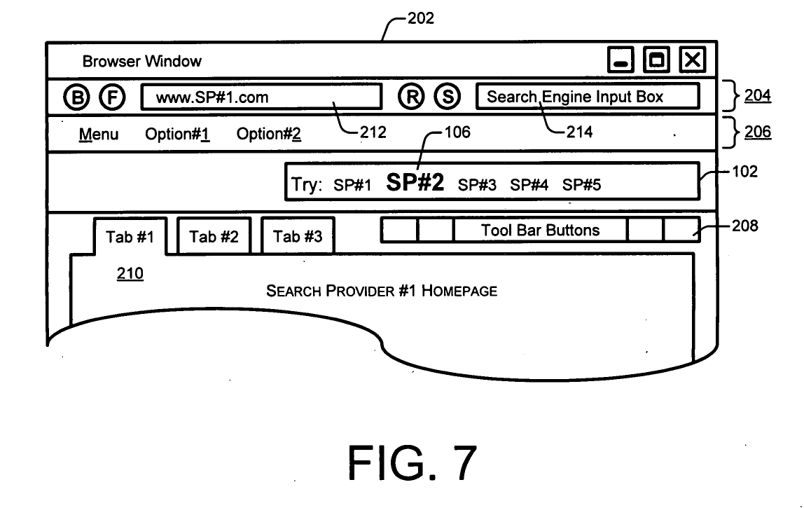

If the user is detected to select the recommended search provider, then at block 310 the search results from the recommended search provider for the search query input are presented responsive to the selection. If, on the other hand, the user is not detected to select the recommended search provider (at block 308), then at block 312 the UI may continue to be monitored for user selection of an alternative search provider. Although not explicitly shown in FIG. 3, the UI may also be monitored to detect if the user selects another (e.g., non-recommended) search provider that is also presented (e.g., as shown in FIG. 7).

FIG. 4 is a block diagram 400 that illustrates an example search provider recommendation component 402. As illustrated, block diagram 400 includes search provider recommendation component 402 and a display screen 412. Search provider recommendation component 402 includes a search input interface component 404, a recommended search provider ascertainment component 406, a UI modification component 408 (for recommended search providers), and a recommended search provider selection component 410. Display screen 412 includes UI 414.

For example embodiments, search provider recommendation component 402 is adapted to facilitate search provider switching by implementing one or more of the acts of flow diagram 300 (of FIG. 3). The components of search provider recommendation component 402 may be realized as processor-executable instructions that are executed by a processing device (e.g., of FIG. 12). A display screen 412 that is integrated with or coupled to the device may display UI 414. UI 414 may present the various user interface elements that are described herein and illustrated in the accompanying FIGS.

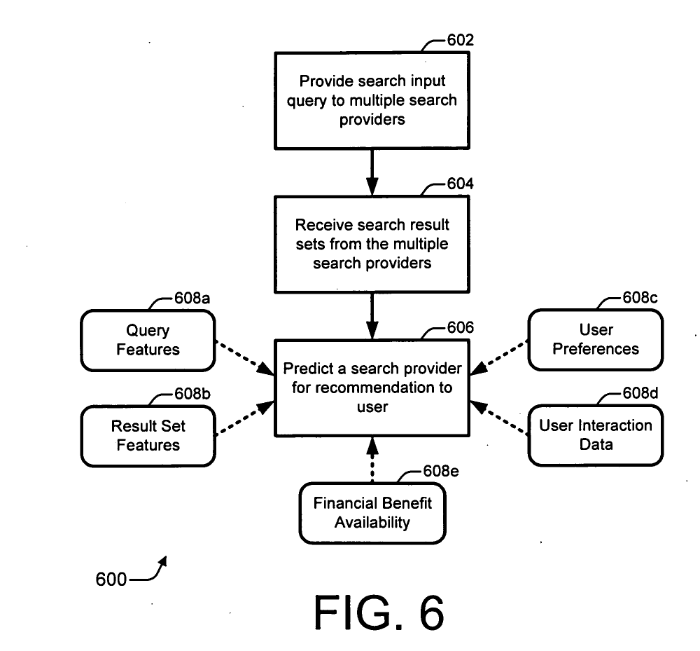

Search input interface component 404 is to receive a search query input 108 (of FIG. 1). Example embodiments for receiving a search query input are described herein below with particular reference to FIG. 5. Recommended search provider ascertainment component 406 is to ascertain at least one recommended search provider 110(2) at least partially responsive to search query input 108. (It should be understood that in some circumstances no recommended search provider may be ascertained.) The recommended search provider may be ascertained by local prediction or by receiving a recommendation from a remote prediction. Example embodiments for predicting a recommended search provider are described herein below with particular reference to FIG. 6.

UI modification component 408 is to modify a user interface 414 to indicate at least one recommended search provider 110(2). Example embodiments for modifying a UI to indicate a recommended search provider are described herein below with particular reference to FIGS. 7, 8, 10, and 11. Additionally, a UI may be modified by automatically presenting search results from a recommended search provider in response to receiving a search query input. Recommended search provider selection component 410 detects if the user selects the recommended search provider 110(2). If the user does select the recommended search provider, recommended search provider selection component 410 presents the search results from the recommended search provider for the search query input.

In an example implementation, search provider recommendation component 402 is an agnostic application. In other words, each search provider has an equal opportunity to be recommended as any other available search provider. In an alternative implementation, search provider recommendation component 402 may be configured to recommend switching search providers when a particular search provider (or providers) is predicted to produce more desirable search results. In yet another implementation, it may be configured to try to recommend switching search providers when a browser is pointing to a predetermined other search provider.

Search provider recommendation component 402 may be an independent application. Alternatively search provider recommendation component 402 may be part of another application. For example, it may be implemented as a plug-in for a Web browser. It may also be incorporated as part of an operating system for a client or for a server or incorporated into another application. Furthermore, it may be otherwise embedded in different devices.

FIG. 5 depicts a browser window 202 that illustrates example origination sources for a search query input 108. A search query input 108 may originate and be received from any of many possible sources. Three examples are explicitly shown in FIG. 5. First, a search query input 108a may be received via a search engine input box 214. Second, a search query input 108b may be received via a text input block that is part of a search recommendation UI element 102.

Third, a search query input 108c may be received via a block that is part of a homepage of a search provider. As shown by current URL block 212, the browser is currently pointing to the homepage of search provider #1 (SP #1). Generally, a search query input 108 may also be received via a search input box on any page of any website. Outside of the browser, a search query input 108 may be received via the search interface of other applications, including programs and/or an operating system.

FIG. 6 is a flow diagram 600 that illustrates an example of a method for predicting a recommended search provider. Flow diagram 600 includes three action blocks 602-606 and five criteria blocks 608a-608e. Implementations of flow diagram 600 may be realized, for example, as processor-executable instructions and/or as part of recommended search provider ascertainment component 406 (of FIG. 4). When a recommended search provider is predicted locally, the acts of flow diagram 600 may be performed by search provider recommendation component 402. Alternatively, the acts of flow diagram 600 may be performed remotely.

For example embodiments, at block 602, a search input query is provided to multiple search providers. At block 604, respective search result sets are received from respective ones of the multiple search providers. At block 606, a recommended search provider is predicted for the user. The prediction may be based on one or more criteria 608, such as those that are illustrated. It should be noted that if the recommended search provider is being predicted without factoring result set features into the prediction mechanism, the acts of blocks 602 and 604 may be omitted.

By way of example, one or more of the following criteria 608 may be factored into the prediction: query features 608a, result set features 608b, user preferences 608c, user interaction data 608d, financial benefit availability 608e, some combination thereof, and so forth. These features may be incorporated into a machine learning approach that creates a classifier to predict a search provider that is to be recommended to a user at least partially responsive to the search query input. The output of a machine learning algorithm or other prediction mechanism may include a confidence level that reflects the likelihood that the recommended search provider is actually more appropriate for the user given the search query input.

Example approaches to making predictions for search provider recommendations are also described in a U.S. Nonprovisional patent application Ser. No. 12/146,813, filed on 26 Jun. 2008 and entitled “Automatic Classification of Search Engine Quality”. U.S. Nonprovisional patent application Ser. No. 12/146,813 has some overlapping inventorship and the same assignee as the Instant Patent Application. It should be understood that the embodiments described herein for ascertaining a recommended search provider may use approaches for predicting a recommended search provider other than those described herein and/or in U.S. Nonprovisional patent application Ser. No. 12/146,813.

Query features 608a may include, but are not limited to, number of characters, number of words, word lengths, word types, combinations thereof, and so forth. Result set features 608b may include, but are not limited to, features from the results pages, features relating to word matches, combinations thereof, and so forth. Examples of user preferences 608c are described herein below.

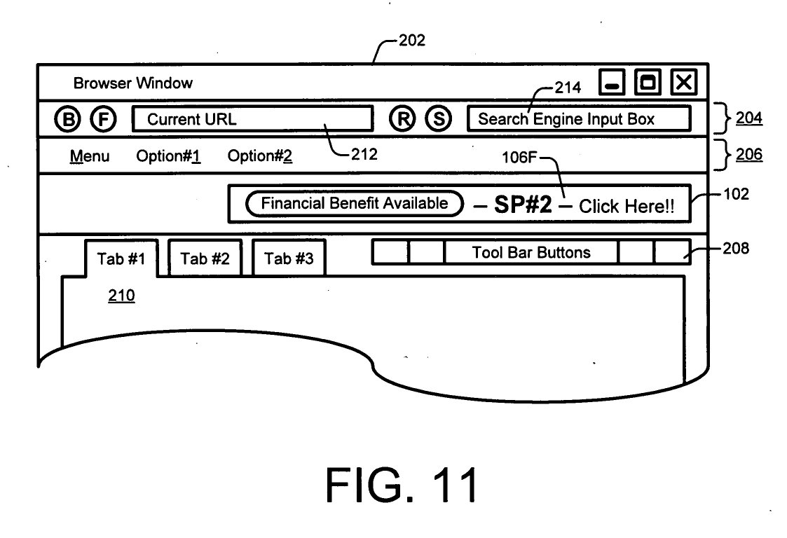

User interaction data 608d may refer to a search history or search histories, a browsing history or histories, other data gleaned from user information (e.g., a user profile), some combination thereof, and so forth. Additionally, past and/or current user interactions with a given search provider and/or a set of search results may be used to predict another search provider. Financial benefit availability 608e is a criterion that reflects whether a user may attain a financial benefit by using a particular search provider. Example embodiments pertaining to the availability a financial benefit are described herein below with particular reference to FIG. 11.

Before user interaction data 608d (or other personal information including, but not limited to, browsing and searching histories) is retained, analyzed, or otherwise utilized, notice to the user is provided. The types of information that are to be collected and utilized as well as the purposes for doing so may be communicated. Furthermore, an opt-out opportunity may be provided to the user. With an opt-out opportunity, the user is given the opportunity to prevent the collection or utilization of such information. Moreover, an opt-in provision may be instituted. With an opt-in provision, no personal information is collected or utilized unless the user affirmatively approves of the process. Even if the user does agree to the collection and utilization of data for the expressly-stated purposes, any such data that is transported away from the user's device may be rendered anonymous and/or untraceable.

FIG. 7 depicts a browser window 202 that illustrates an example indication of a recommended search provider. In an example embodiment, search recommendation UI element 102 is modified as compared to a non-recommendation mode (e.g., as shown in FIG. 2). More specifically, search recommendation UI element 102 includes a search provider recommendation indication 106. This mode may be activated, for example, when search results for a given search provider are displayed in tab 210. In the illustrated example, respective representations of multiple respective search providers 110 (of FIG. 1) are presented in search recommendation UI element 102. The recommended search provider, search provider #2 (SP #2), is emphasized at search provider recommendation indication 106.

As shown, the representations of the search providers comprise names of the search providers. Alternative representations include, but are not limited to, abbreviations, URLs, icons, combinations thereof, etc. of the search providers. As explicitly illustrated in FIG. 7, search provider #2 (SP #2) is emphasized by increasing the size of the font of its representation and rendering the lettering in bold. Alternative approaches to emphasizing a search provider to indicate a recommendation include, but are not limited to, changing the font, changing the color, making text “sparkly”, changing the background around the lettering, showing a hover-over box, some combination thereof, and so forth.

Moreover, a recommended search provider may be emphasized by de-emphasizing the representations of the other search providers (e.g., changing their text or icon to gray, partial transparency, etc.). Furthermore, a recommended search provider may be emphasized by presenting the recommended search provider (e.g., in search recommendation UI element 102) while excluding (e.g., removing or merely not including) any other search providers. Other approaches to emphasizing a recommended search provider may alternatively be implemented.

When a user selects the recommended search provider #2, the search results listing from the recommended search provider is presented. The selection may be effected, for example, by clicking on search provider recommendation indication 106 with a mouse, a finger, a key or keyboard combination, and so forth. A preview of the search results (e.g., the top three) from the recommended search provider may also be presented (e.g., on mouse hover). The user may also select any of the non-emphasized other search providers. Selection of a non-emphasized search provider may cause the search results for the search input query from the selected non-recommended search provider to be presented to the user.

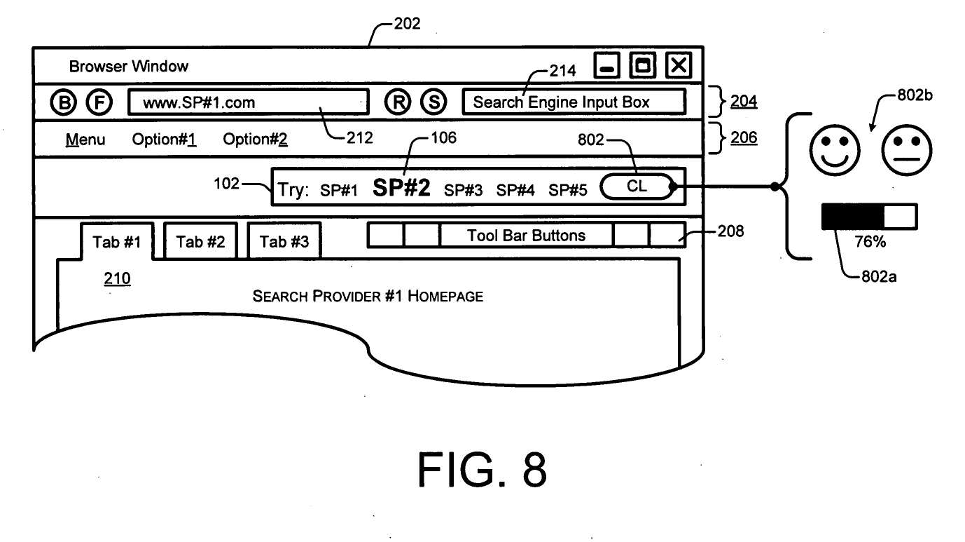

FIG. 8 depicts a browser window 202 that illustrates example implementations of indicators for revealing a confidence level 802 supporting a search provider recommendation. As illustrated, search recommendation UI element 102 includes a representation of confidence level 802. This enables the user to have some measure of the strength of the prediction supporting the recommended search provider. In an example implementation, users are allowed to adjust the minimum confidence level threshold that is to be met to make a search provider recommendation. The user may also set search recommendation UI element 102 to automatically switch to a recommended search provider, especially if the confidence level exceeds a particular threshold.

The representation may be a bar 802a revealing the likelihood of the prediction being correct (e.g., with the confidence level score being in a percentage form). The example bar 802a shows a 76% likelihood of the prediction being correct. Alternatively, icons 802b may reveal the likelihood of the prediction being correct in a less-precise but more user friendly format. Example icons 802b include, but are not limited to, arrows, thumbs up/down, emoticons (as shown), and so forth.

Other UI techniques may be used to attract the user's attention, such as blinking all or a portion of the button panel. Also, alternative confidence level 802 representations may be implemented. For example, the background color of the panel (e.g., the entirety of search recommendation UI element 102, the portion under search provider recommendation indication 106, etc.) may be changed depending on the confidence level. For instance, a green color may reflect a strong recommendation with yellow reflecting a medium-strength recommendation. Also, the relative font sizes may be adjusted to convey the potential relevance of a particular search provider relative to its competitors, overlay “ticklers” that recommend search provider switching may be shown over a Web page, a new set of search results may be automatically opened in a new browser tab, combinations thereof, and so forth.

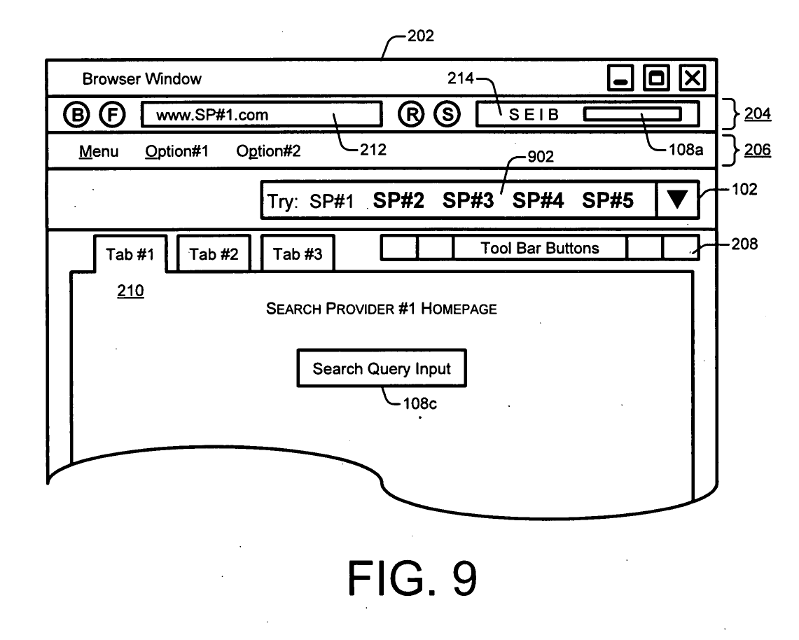

FIG. 9 depicts a browser window 202 that illustrates an example mode for a search recommendation UI element 102 when the browser is pointed to a homepage of a search provider. The browser is currently pointed to the homepage of search provider #1 (SP #1) as indicated by current URL block 212. In this example mode, search recommendation UI element 102 emphasizes the search providers #2-#5 to which the browser is not currently pointing. This enables a user to have, e.g., one-click access to other search providers to facilitate spontaneous search provider switching. Selecting one of the other search providers can point the browser toward the homepage of the other search provider.

This mode of search recommendation UI element 102 may be active at the homepage or any other page of a search provider. It may also be a default mode that constantly provides one-click access to a number of different search providers as the user browses the internet. In another example default mode, search recommendation UI element 102 may include a search query input block which, when the user enters a search query into it, automatically takes the user to whichever search provider the component predicts will return desirable results for the search query. This example default mode is shown in FIG. 5. As noted above, search recommendation UI element 102 need not be part of a browser window (or presented by a browser program). Additional example alternatives for a search recommendation UI element 102 include, but are not limited to, balloon tips (e.g., on a task bar), operating system sidebar suggestions, desktop search pop-ups, combinations thereof, and so forth.

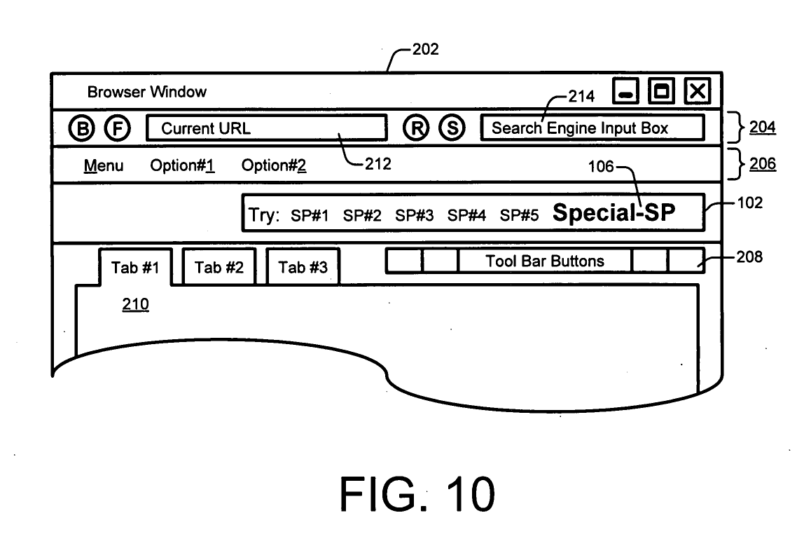

FIG. 10 depicts a browser window 202 that illustrates an example mode for recommending a special-purpose search provider. As illustrated, search recommendation UI element 102 includes a search provider recommendation indication 106 for a special-purpose search provider. As shown, the button panel expands and a representation of the specialized search provider is included. Alternatively, space for one or more specialized search providers may be reserved as part of a standard mode of search recommendation UI element 102.

In an example embodiment, search recommendation UI element 102 usually presents one or more representations of general web-focused search providers. However, specialized search providers can also provide value to users. For example, vertical search providers focus on at least one predetermined topical category. Example topical categories include health matters, financial matters, technological matters, political matters, and so forth. Specialized search providers may be analyzed in manners analogous to “standard” search providers. Alternatively, and by way of example, the search queries that users input to these specialized search providers can be analyzed independently. The analysis can be applied to predicting a recommended special-purpose search provider and/or arbitrating between instant answers.

Instead of merely including one specialized search provider (as shown in FIG. 10), search recommendation UI element 102 may present a ranked list of special-purpose search providers for the current search query input. The ranked list may display their names, their icons, both, or some other representation(s). Moreover, hierarchy-based or ontology-based views of specialized search providers may be presented. For example, a user interface element (e.g., a pop-up menu) may be presented that empowers users to move horizontally (e.g., to similar special-purpose search providers) or vertically (e.g., to more general or more specific special-purpose search providers).

FIG. 11 depicts a browser window 202 that illustrates an example mode for recommending a search provider when a financial benefit is available to the user. As illustrated, search recommendation UI element 102 includes a financial-benefit-related search provider recommendation indication 106F. As described herein above with particular reference to FIG. 6, financial benefit availability 608e is a criterion that reflects whether a user may attain a financial benefit by using a particular search provider.

Thus, in an example embodiment, search provider recommendation indication 106F may indicate when a financial benefit is available to a user of a particular search provider. A financial benefit may include a discount on a product or service, an opportunity to receive cash back with a purchase, an ability to earn reward points, some combination thereof, and so forth.

Hence, search recommendation UI element 102 may also recommend a search provider based on other factor(s), such as monetary savings, that are available on the target search provider for product or service (or other purchase-oriented) searches. The button panel may be, for instance, caused to gleam to recommend switching to a particular search provider when a financial benefit is available via that particular search provider. A financial-benefit-related search provider recommendation indication 106F may also be based on offers from particular merchants, offers on particular products, offers with a threshold percentage/monetary benefit, combinations thereof, and so forth. When a threshold percentage/monetary benefit is involved, the threshold may be user selectable.

Additional example functionality for search provider recommendation component 402 (of FIG. 4) is described. First, search results that were previously presented in a given session by the original search provider may be excluded from or noted in the search results presented from a different (e.g., recommended) search provider after the switch. Second, the user may be empowered to customize the list of search providers used. Also, the relative importance of the recommendations from each of the selected search providers may be adjustable by the user. For example, a user may wish to receive recommendations from search provider #3 with a lower frequency (and/or at a higher confidence level threshold) than from search provider #2 or other search providers generally.

Third, search provider recommendation component 402 may pre-fetch search results from each of the selected search providers so that search result listings from such search providers appear faster if/when they are requested by the user. Fourth, the user may be empowered to tune numeric thresholds used for the confidence values that are to be met in order to recommend a switch to a different search provider. For instance, a user may set search recommendation UI element 102 to be 95% confident that there will be a benefit from the switch before making a recommendation to do so. Also, a user may set the component to make a recommendation whenever a financial benefit is available, regardless of the confidence level or impact of other recommendation criteria.

Six additional example capabilities for search provider recommendation component 402 (of FIG. 4) are described. First, it may offer explanations about why the search provider switch is being recommended. More specifically, after recommending a search provider switch, the component may offer an explanation as to why a particular search provider is being recommended. The explanation may include, for example, noted relevant features associated with the recommended search provider (e.g., a high number of query terms on the results page). Furthermore, explanations may indicate that a recommended search provider is expected to have more relevant results, more applicable topic coverage, more recent results, and so forth. The explanation may be presented, for instance, in a tool-tip or drop-down menu that is available on mouse hover.

The component may allow users to up-weight, down-weight, or exclude specific features used by the component in determining whether a switch is to be recommended, depending on user perception of their value. Explanations may also be offered on the results page of the post-switch search provider. For example, these explanations may be implemented as result overlays presented next to each search result, with each overlay indicating the value or differences in the results from the pre-switch engine.

Second, search recommendation UI element 102 may be configured to automatically navigate users to the recommended search provider. More specifically, users can be automatically directed to the recommended search provider if the confidence level reflecting the predicted quality of the search results is sufficiently high. In one implementation, users issue the search query to the search provider of their choice (e.g., at the chosen search provider's home page at search query input 108c) and/or at search engine input box 214, and they are then transported to the recommended search provider. In other words, if the switching component is sufficiently confident that another search provider is likely to produce higher quality results, the user is redirected to that search provider. After the redirection, a message may be displayed to the user that states, for example: “Your search provider has been switched because <insert reason>. Click here to return to the original search provider.” Example reasons for switching a search provider are described herein above in the context of reasons for recommended a search provider.

In another implementation, search recommendation UI element 102 may be merged with search engine input box 214 and/or with the underlying browser. Although users issue search queries to a designated search provider (or the browser itself), they are automatically directed to the recommended search provider based on the confidence level. In yet another implementation, search recommendation UI element 102 may include one-click functionality to be transported to the recommended search engine. Selecting such a “Recommended Search Provider” button directs users to the highest rated search provider responsive to the currently-input search query in a single mouse click.

Third, search provider recommendation component 402 may be configured to make recommendations at appropriate times. More specifically, in addition to making decisions about when there exists a set of search results of a predicted higher quality for a given search query, the component may also be adapted to understand a user's focus of attention, workload, and willingness to be interrupted, so as to enable it to present recommendations at an appropriate time. For example, the user may be empowered to explicitly specify how frequently they will tolerate an interruption. As another example, the component may construct probabilistic models of attention that estimate when it is acceptable to interrupt the user. These models may rely on a minimum threshold value in the performance difference between two search providers that is to be met before the system makes a switching recommendation; the threshold may also be tunable by users or adapted automatically based on user interaction with the component.

Fourth, search provider recommendation component 402 may be capable of inferring the nature of the current task and modifying its search provider recommendations accordingly. More specifically, search provider switching may not be appropriate for all search tasks. For example, if the search query is purely navigational (e.g., a query of “URL-name” submitted to get to the corresponding company/website), then it is unlikely that a user will want to switch search providers. Recommending a switch in such circumstances will likely lead to user distraction and dissatisfaction.

The switch recommendation component may include a mechanism to infer the nature of the search task from user interaction behavior, such as search queries and page visits. The component can decide whether or not to make a search provider recommendation based on the nature of the task. In an alternative implementation, the switching component may direct users to different engines depending on the nature of the task, the nature of the query, and so forth. For example, search provider #4 may have more appropriate search results or a more desirable search interface for exploratory tasks, search provider #3 may be more effective for news queries, search provider #1 may be more effective for sports queries, and so forth.

Fifth, search provider recommendation component 402 may be capable of inferring when users are unhappy with the switching component and/or their current search provider. More specifically, by tracking the recent interaction history of users, the switching component can automatically determine when users are unhappy with the component (e.g., they ignore its suggestions for a single query or across multiple queries) or with their current search provider (e.g., they request the next page of search results, the search engine returns no results, they issue a number of queries in quick succession, etc.).

In response to a determination of dissatisfaction, the component can adjust weights that affect its activation frequency (e.g., if users are dissatisfied with it) or can make an instantaneous recommendation to switch to an alternative search provider (e.g., if users appear unhappy with the current search provider). Alternatively, the component can capture explicit feedback from users about their perceptions of the current search provider and/or the current tendencies of the recommendation component. Furthermore, negative feedback about a recommendation or search provider may be captured and used to down-weight or exclude particular providers or recommendations for future search queries.

Sixth, persistent personalized profiles may be created to be used during switching recommendations. More specifically, switching recommendation support may be tailored to a current user to increase the accuracy of the switching recommendations using persistent profiles. Such persistent profiles may also be subject to opt-in/opt-out requirements. Furthermore, users may have control over the length of time the profiles are retained and how/whether the profiles are transmitted beyond the user's device.

Persistent profiles may be created to capture information pertaining to any one or more of the following five areas: (1) Search history—Previous sets of queries and result clicks that capture short- and long-term user interests. (2) Bandwidth—Users on slow connections may not want to be pointed to an engine with large result pages. Moreover, users on slow connections can send their query to a server that is to query the other search providers, download their result sets, predict a search provider, and identify the recommended search provider to the client. This can reduce network bandwidth loads.

(3) Geolocation—Search providers perform differently in different markets. Hence, the recommendation component may factor geolocation into the recommending mechanism. (4) Search provider preferences-Prior probabilities of selecting or using each of multiple search providers may be determined. These prior probabilities may also be factored into a recommendation mechanism. (5) Query preferences—Users may be empowered to disable switching recommendations for certain queries or certain classes of queries (e.g., automobile-related searches).

Thus, profile information about the user may be leveraged when making switching recommendations. When profiles are factored into the recommendation mechanism, users may be empowered to control the extent to which their profile is used in making recommendations. For example, users may be capable of varying the amount of their history that is used in making switching recommendations. Also, the switching recommendation component can point users to a previously-untried search provider to broaden their awareness and experience with different providers.

FIG. 12 is a block diagram 1200 illustrating example devices 1202 that may be used to implement embodiments for recommending search providers. As illustrated, block diagram 1200 includes two devices 1202a and 1202b, person-device interface equipment 1212, and one or more network(s) 1214. As explicitly shown with device 1202a, each device 1202 may include one or more input/output interfaces 1204, at least one processor 1206, and one or more media 1208. Media 1208 may include processor-executable instructions 1210.

For example embodiments, device 1202 may represent any processing-capable device. Example devices 1202 include personal or server computers, hand-held or other portable electronics, entertainment appliances, network components, some combination thereof, and so forth. Device 1202a and device 1202b may communicate over network(s) 1214. Network(s) 1214 may be, by way of example but not limitation, an internet, an intranet, an Ethernet, a public network, a private network, a cable network, a digital subscriber line (DSL) network, a telephone network, a wireless network, some combination thereof, and so forth. Person-device interface equipment 1212 may be a keyboard/keypad, a touch screen, a remote, a mouse or other graphical pointing device, a display screen, a microphone/speaker, and so forth. Person-device interface equipment 1212 may be integrated with or separate from device 1202a.

I/O interfaces 1204 may include (i) a network interface for monitoring and/or communicating across network 1214, (ii) a display device interface for displaying information on a display screen, (iii) one or more person-device interfaces, and so forth. Examples of (i) network interfaces include a network card, a modem, one or more ports, a network communications stack, a radio, and so forth. Examples of (ii) display device interfaces include a graphics driver, a graphics card, a hardware or software driver for a screen or monitor, and so forth. Examples of (iii) person-device interfaces include those that communicate by wire or wirelessly to person-device interface equipment 1212.

Processor 1206 may be implemented using any applicable processing-capable technology, and one may be realized as a general-purpose or a special-purpose processor. Examples include a central processing unit (CPU), a microprocessor, a controller, a graphics processing unit (GPU), a derivative or combination thereof, and so forth. Media 1208 may be any available media that is included as part of and/or is accessible by device 1202. It includes volatile and non-volatile media, removable and non-removable media, storage and transmission media (e.g., wireless or wired communication channels), hard-coded logic media, combinations thereof, and so forth. Media 1208 is tangible media when it is embodied as a manufacture and/or as a composition of matter.

Generally, processor 1206 is capable of executing, performing, and/or otherwise effectuating processor-executable instructions, such as processor-executable instructions 1210. Media 1208 is comprised of one or more processor-accessible media. In other words, media 1208 may include processor-executable instructions 1210 that are executable by processor 1206 to effectuate the performance of functions by device 1202. Processor-executable instructions 1210 may be embodied as software, firmware, hardware, fixed logic circuitry, some combination thereof, and so forth.

Thus, realizations for recommending search providers may be described in the general context of processor-executable instructions. Processor-executable instructions may include routines, programs, applications, coding, modules, protocols, objects, components, metadata and definitions thereof, data structures, APIs, etc. that perform and/or enable particular tasks and/or implement particular data types. Processor-executable instructions may be located in separate storage media, executed by different processors, and/or propagated over or extant on various transmission media.

As specifically illustrated, media 1208 comprises at least processor-executable instructions 1210. Processor-executable instructions 1210 may comprise, for example, search provider recommendation component 402 (of FIG. 4). Generally, processor-executable instructions 1210, when executed by processor 1206, enable device 1202 to perform the various functions described herein. Such functions may include, by way of example, those that are illustrated in flow diagrams 300 and 600 (of FIGS. 3 and 6) and those pertaining to features illustrated in the various depictions of UI elements, as well as combinations thereof, and so forth.

The devices, acts, features, functions, methods, modules, data structures, techniques, components, UIs, etc. of FIGS. 1-12 are illustrated in diagrams that are divided into multiple blocks and other elements. However, the order, interconnections, interrelationships, layout, etc. in which FIGS. 1-12 are described and/or shown are not intended to be construed as a limitation, and any number of the blocks and/or other elements can be modified, combined, rearranged, augmented, omitted, etc. in many manners to implement one or more systems, methods, devices, media, apparatuses, arrangements, etc. for search provider recommendation.

Although systems, methods, devices, media, apparatuses, arrangements, and other example embodiments have been described in language specific to structural, logical, algorithmic, and/or functional features, it is to be understood that the invention defined in the appended claims is not necessarily limited to the specific features or acts described above. Rather, the specific features and acts described above are disclosed as example forms of implementing the claimed invention.

What is claimed is:

1. One or more processor-accessible tangible media comprising processor-executable instructions for recommending a search provider, wherein the processor-executable instructions, when executed, direct a device to perform acts comprising:
receiving a search query input;
ascertaining at least one recommended search provider at least partially responsive to the search query input; and
modifying a user interface by emphasizing the at least one recommended search provider and by indicating that the at least one recommended search provider offers a financial benefit.

2. The one or more processor-accessible tangible media as recited in claim 1, wherein the act of ascertaining comprises:
predicting the recommended search provider based on at least one financial benefit availability criterion.

3. The one or more processor-accessible tangible media as recited in claim 2, wherein the financial benefit comprises a discount on a product or service, an opportunity to receive cash back, or an ability to earn reward points.

4. The one or more processor-accessible tangible media as recited in claim 3, wherein the processor-executable instructions comprise at least part of a browser or at least part of a search tool plug-in for a browser.

5. A device-implemented method for recommending a search provider, the method comprising acts of:
receiving a search query input;
ascertaining at least one recommended search provider at least partially responsive to the search query input; and
modifying a user interface to indicate the at least one recommended search provider.

6. The method as recited in claim 5, further comprising acts of:
recognizing that a user intends to conduct a search; and
modifying the user interface to present multiple search providers that can each be selected for use to conduct the search.

7. The method as recited in claim 5, further comprising acts of:
detecting if a user selects the recommended search provider; and
if the user is detected to select the recommended search provider, presenting search results from the recommended search provider with regard to the search query input.

8. The method as recited in claim 5, wherein the act of receiving comprises:
receiving the search query input via a search input block of a web page, via a search input block of a search engine input box of a browser, or via a search input block of a search recommendation user interface element.

9. The method as recited in claim 5, wherein the act of ascertaining comprises:
predicting the recommended search provider at least partially responsive to the search query input; or
receiving the recommended search provider from a remote location, the recommended search provider predicted at least partially responsive to the search query input.

10. The method as recited in claim 5, wherein the act of ascertaining comprises:
predicting the recommended search provider at least partially responsive to the search query input and based on one or more of multiple criteria factored into a learned algorithmic recommendation mechanism.

11. The method as recited in claim 10, wherein the multiple criteria include one or more of query features, result set features, user preferences, user interaction data, and financial benefit availability.

12. The method as recited in claim 5, wherein:
the act of ascertaining comprises predicting the recommended search provider based on at least one financial benefit availability criterion; and
the act of modifying comprises modifying the user interface to further indicate that the recommended search provider offers a financial benefit.

13. The method as recited in claim 5, wherein the act of modifying comprises:
transporting a user to the at least one recommended search provider by automatically presenting search results produced by the at least one recommended search provider.

14. The method as recited in claim 5, wherein the act of modifying comprises:
indicating the recommended search provider by emphasizing a representation corresponding to the recommended search provider; or
indicating the recommended search provider by deemphasizing one or more other respective representations corresponding to one or more other search providers that are not being recommended.

15. A device that is capable of recommending a search provider, the device comprising:
a search provider recommendation component to present at least one recommended search provider to a user, the search provider recommendation component including:
a search input interface component to receive a search query input;
a recommended search provider ascertainment component to ascertain the at least one recommended search provider at least partially responsive to the search query input; and
a user interface modification component to modify a user interface to indicate the at least one recommended search provider.

16. The device as recited in claim 15, wherein the recommended search provider is associated with a confidence level; and wherein the user interface modification component is to present a representation of the confidence level in conjunction with indicating the recommended search provider.

17. The device as recited in claim 15, wherein the search provider recommendation component is to empower the user to set a confidence level threshold that is to be met before a search provider is recommended.

18. The device as recited in claim 15, wherein the recommended search provider comprises a special-purpose search provider that focuses on at least one predetermined category.

19. The device as recited in claim 18, wherein the user interface modification component is to present a user interface element that enables the user to move horizontally to similar special-purpose search providers or vertically to relatively more-general or more-specific special-purpose search providers.

20. The device as recited in claim 15, wherein the search provider recommendation component is to exclude or note particular search results being presented after selection by the user of a different search provider if the particular search results were already presented in a given session by an original search provider.
